(19) United States
(12) Patent Application Publication
(10) Pub. No.: US 2026/0056363 A1
(43) Pub. Date: Feb. 26, 2026

(54) EXTERNAL LAYER WAVEGUIDING IN THIN FILM LITHIUM-CONTAINING PHOTONIC DEVICES

(71) Applicant: HyperLight Corporation, Cambridge, MA (US)

(72) Inventors: Andrew John Mercante, Newark, DE (US); Yuzhou Liu, Cambridge, MA (US); Fan Ye, Lincoln, MA (US); Miles Matthew Kovach, Cambridge, MA (US); Kevin Luke, Cambridge, MA (US); Amirmahdi Honardoost, Somerville, MA (US); Christian Reimer, Wellesley, MA (US); Mian Zhang, Cambridge, MA (US); Sean P. Anderson, Macungie, PA (US)

(21) Appl. No.: 19/308,014

(22) Filed: Aug. 22, 2025

Related U.S. Application Data
(60) Provisional application No. 63/686,680, filed on Aug. 23, 2024.

(51) Int. Cl. G02B 6/132; G02B 6/12; G02B 6/126

(52) U.S. Cl. CPC G02B 6/132; G02B 6/126; G02B 2006/12035; G02B 2006/12097; G02B 2006/12147

(57) ABSTRACT

A photonics device is described. The photonics device includes a device region and a coupling region. The device region has a first portion of a waveguide therein. The coupling region includes a second portion of the waveguide, at least one additional structure, and a cladding separating the additional structure(s) from the second portion of the waveguide. The cladding has a cladding index of refraction. The additional structure(s) has index(es) of refraction greater than the cladding index of refraction. The waveguide includes at least one thin film lithium-containing (TFLC) electro-optic material.

### CROSS REFERENCE TO OTHER APPLICATIONS

This application claims priority to U.S. Provisional Patent Application No. 63/686,680 entitled PASSIVATION LAYER WAVEGUIDING IN THIN FILM LITHIUM-CONTAINING PHOTONIC DEVICES filed Aug. 23, 2024 which is incorporated herein by reference for all purposes.

### BACKGROUND OF THE INVENTION

Lithium-containing (LC) electro-optic materials, such as lithium niobate (LN) and/or lithium tantalate (LT), may be desired to be used in photonics integrated circuits. Thin film lithium-containing (TFLC) materials may include materials such as thin film LN (TFLN) and/or thin film LT (TFLT). The fabrication of TFLC photonics devices presents significant challenges for a variety of reasons. For example, there may be variations in the thickness of LN or LT layers in commercially available wafers. Stated differently, the LN or LT layer is not uniformly thick or uniformly flat. Precise control of the etch depth of LN and LT is also challenging. As a result, various components may be difficult to fabricate with precise tolerances. For example, a low-loss spot size (or mode) converter may be challenging to achieve. It is, therefore, difficult to match modes from an on-chip waveguide to a fiber efficiently. Mismatch of modes causes optical losses and decreased performance from the device. Further, in manufacturing TFLC devices, the critical dimension (CD) of the process limits the minimum feature size and therefore the mode size that is achievable. Again, device performance may suffer. Multi-layer spot size converters that use several high index core materials can be used to achieve low loss and robust spot size converters. However, the use of multiple layers adds to wafer fabrication costs and difficulty. Consequently, techniques for improving the fabrication of TFLC photonics devices, for example including spot/mode converters, are desired.

### BRIEF DESCRIPTION OF THE DRAWINGS

Various embodiments of the invention are disclosed in the following detailed description and the accompanying drawings.

FIGS. 1A-1B are diagrams depicting an embodiment of a photonics device that may have improved optical coupling.

FIGS. 2A-2B depict an embodiment of a portion of a thin film lithium-containing optical device usable in a photonics device.

FIGS. 3A-3D depict an embodiment of a photonics device that may have improved optical coupling.

FIGS. 4A-4B depict embodiments of a photonics device that may have improved optical coupling.

FIG. 5 depicts an embodiment of a photonics device that may have improved optical coupling.

FIG. 6 depicts an embodiment of a photonics device that may have improved optical coupling.

FIG. 7 depicts an embodiment of a photonics device that may have improved optical coupling.

FIG. 8 depicts an embodiment of a photonics device that may have improved optical coupling.

FIG. 9 depicts an embodiment of a photonics device that may have improved optical coupling.

FIG. 10 depicts an embodiment of a photonics device that may have improved optical coupling.

FIGS. 11A-11C depict an embodiment of a photonics device that may have improved optical coupling.

FIGS. 12A-12B depict an embodiment of a photonics device that may have improved optical coupling.

FIGS. 13A-13B depict embodiments of photonics devices that may have improved optical coupling.

FIGS. 14A-14C depict an embodiment of a photonics device that may have improved optical coupling.

FIGS. 15A-15B depict an embodiment of a photonics device that may have improved optical coupling.

FIG. 16 is a flow chart depicting an embodiment of a method for providing a photonics device that may have improved optical coupling.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A photonics device is described. The photonics device includes a device region and a coupling region. The device region has a first portion of a waveguide therein. The device region may include other components and/or may configure the waveguide for various applications. For example, the device region may include electrodes for electro-optic modulation. The device region may configure the waveguide for conversion between TE and TM modes, polarization rotation, and/or other functions. The coupling region includes a second portion of the waveguide, at least one additional structure, and a cladding separating the additional structure(s) from the second portion of the waveguide. In some embodiments, the coupling region includes other components and/or configures the waveguide for various applications. For example, the waveguide may be tapered or otherwise shaped for mode conversion, converting the spot size, and/or other applications. The cladding has a cladding index of refraction. The additional structure(s) have index(es) of refraction greater than the cladding index of refraction. The waveguide includes at least one thin film lithium-containing (TFLC) electro-optic material. For example, the waveguide may include or consist of thin film lithium niobate (TFLN) and/or thin film lithium tantalate (TFLT).

The photonics device may include a substrate. In some embodiments, the second portion of the waveguide in the coupling region is closer to the substrate than the additional structure(s) are. In some embodiments, the additional structure(s) are part of a passivation layer. The passivation has an aperture in the coupling region. Thus, a portion of the cladding and/or other structures may be exposed by the aperture in the passivation layer. In some embodiments, the passivation layer includes at least one of silicon nitride, silicon oxynitride, silicon dioxide, aluminum oxide, or aluminum nitride. In some embodiments, a first portion of the passivation layer extends into the device region and covers the first portion of the waveguide. In some such embodiments, there are multiple additional structures. In some embodiments, the additional structures are separated by not more than five micrometers and are not more than ten micrometers (e.g. in a direction in-plane that may be perpendicular to the direction of the optical signal in the second portion of the waveguide) from the second portion of the waveguide. In some embodiments, the coupling region terminates at a facet of the photonics device. In some such embodiments, the waveguide terminates a nonzero distance from the facet. In some embodiments, the waveguide terminates at the facet.

In some embodiments, additional waveguiding structures are adjacent to the second portion of the waveguide. Such additional waveguiding structures might be considered a particular embodiment of the additional structures. These additional waveguiding structures may be closer to the substrate than the remaining additional structure(s) are. In some embodiments, the additional waveguiding structures are essentially the same distance from the substrate as the waveguide is. For example, the additional waveguiding structures and the waveguide may be formed from the same TFLC electro-optic layer. In other embodiments, the additional waveguiding structures may be formed from a different material than the waveguide. In some such embodiments, there are multiple additional structures. In some embodiments, these additional structures are aligned (e.g. vertically aligned) with the second portion of the waveguide and the additional waveguiding structures. In some embodiments, the additional structures are offset from (e.g. not vertically aligned) the second portion of the waveguide and the additional waveguiding structures. In some embodiments, the additional waveguiding structures include additional TFLC electro-optic material(s).

In some embodiment, an additional passivation layer (e.g. separate from a passivation layer used for the additional structure(s)) is present at least in the coupling region. The coupling region may terminate in a facet. In such embodiments, at least part of the additional passivation layer is on the facet.

A photonics device including a substrate, a waveguide, a passivation layer and cladding is described. The waveguide includes a first portion in a device region and a second portion in a coupling region. The coupling region may terminate at a facet of the photonics device. The passivation layer has an aperture and additional structures in the coupling region. The second portion of the waveguide is closer to the substrate than the additional structures are. The cladding separates the additional structures from the second portion of the waveguide. The cladding has a cladding index of refraction less than the additional structures having at least one index of refraction greater than the cladding index of refraction. The waveguide includes at least one TFLC electro-optic material. In some embodiments, the photonics device includes additional waveguiding structures adjacent to the second portion of the waveguide in the coupling region. The additional waveguiding structures are closer to the substrate than additional structures are. The additional waveguiding structures include additional TFLC electro-optic material(s). The additional TFLC electro-optic material(s) may be the same as the TFLC electro-optic material(s). In some embodiments, an additional passivation layer is on the coupling region.

A method is described. The method includes providing a waveguide on a substrate. A first portion of the waveguide is in a device region. A second portion of the waveguide is in a coupling region that terminates at a facet of a photonics device. The method also includes providing cladding and providing a passivation layer. The passivation layer includes an aperture and additional structures in the coupling region. The second portion of the waveguide is closer to the substrate than the additional structures are. The cladding separates the additional structures from the second portion of the waveguide. The cladding has a cladding index of refraction. The additional structures have index(es) of refraction greater than the cladding index of refraction. The waveguide includes at least one TFLC electro-optic material. In some embodiments, providing the waveguide further includes providing additional waveguiding structures. In some embodiments, the additional waveguiding structures are separately provided. The additional waveguiding structures are adjacent to the second portion of the waveguide and closer to the substrate than the additional structures are. The plurality of additional waveguiding structures include at least one additional TFLC electro-optic material. In some embodiments, the passivation layer includes at least one of silicon nitride, silicon oxynitride, silicon dioxide, aluminum oxide, or aluminum nitride. In some embodiments, the method also includes providing an additional passivation layer on the coupling region.

Various features of the electro-optic devices are described herein. One or more of these features may be combined in manners not explicitly described herein. The optical devices described herein may be formed using electro-optic materials, such as thin film lithium-containing (TFLC) electro-optical materials. For example, thin film lithium niobate (TFLN) and/or thin film lithium tantalate (TFLT) may be used for the components described. TFLC optical devices use layer(s) of TFLC material that may have a thickness not exceeding three micrometers prior to fabrication of components, such as waveguides, therein. In some embodiments, the TFLC may have a thickness of not greater than one micrometer prior to fabrication of components therein. In general, components are thinner. For example, a TFLC waveguide in an optical modulator may include a ridge and a slab portion. The total thickness of the waveguide (e.g. ridge height plus slab height) may be less than one micrometer as-fabricated. In some embodiments, the total thickness of the waveguide may not exceed five hundred nanometers as-fabricated. In some embodiments, the total thickness of the waveguide may not exceed four hundred nanometers as-fabricated. In some embodiments, the total thickness of the waveguide may not exceed three hundred nanometers as-fabricated. Other thicknesses are possible. Because TFLN is frequently used in such TFLC devices, the systems, methods, and techniques described herein may be discussed in the context of TFLN. However, one of ordinary skill in the art will recognize that the techniques described herein apply to other TFLC devices (e.g. TFLT devices). Wherever a TFLN or thin film lithium niobate integrated circuit is described, a thin film lithium tantalate integrated circuit or other lithium-containing integrated circuit may also be used.

Although primarily described in the context of TFLC electro-optic materials, such as TFLN and TFLT, other nonlinear optical materials may be used in the optical devices described herein. For example, other ferroelectric nonlinear (e.g. second order) optical materials may also be desired to be used in, e.g., waveguides, modulators, polarization rotators, and/or mode converters. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguides and other structures described herein are low optical loss optical structures. For example, a waveguide may have a total optical loss of not more than 10 dB through the portion of waveguide (e.g. when biased at maximum transmission and as a maximum loss) in proximity to electrodes used in modulating the optical signal. The total optical loss is the optical loss in a waveguide through a single continuous electrode region (e.g. as opposed to multiple devices cascaded together). In some embodiments, the waveguide has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, the waveguide has an optical loss of not more than 3 dB/cm (e.g. on average). In some embodiments, the nonlinear material(s) in the waveguides has an optical loss of not more than 2.0 dB/cm. In some such embodiments, the waveguide has an optical loss of not more than 1.0 dB/cm. In some embodiments, the waveguide has an optical loss of not more than 0.5 dB/cm. In some embodiments, the low optical losses are associated with a low surface roughness of the side walls of the waveguides.

The waveguides and other optical structures may have improved surface roughness. For example, the short range root mean square surface roughness of a sidewall of the rib may be less than ten nanometers. In some embodiments, this root mean square surface roughness is not more than five nanometers. In some cases, the short range root mean square surface roughness does not exceed two nanometers. In some embodiments, a waveguide includes a rib portion and a slab portion. The height of such a rib portion is selected to provide a confinement of the optical mode such that there is a 10 dB reduction in intensity from the intensity at the center of the rib at ten micrometers from the center of the rib. For example, the height of the rib is on the order of a few hundred nanometers in some cases. However, other heights are possible in other embodiments. Various other optical components may be incorporated into the waveguide to provide the desired functionality. For example, the waveguide may have wider portion(s) for accommodating multiple modes or performing other functions.

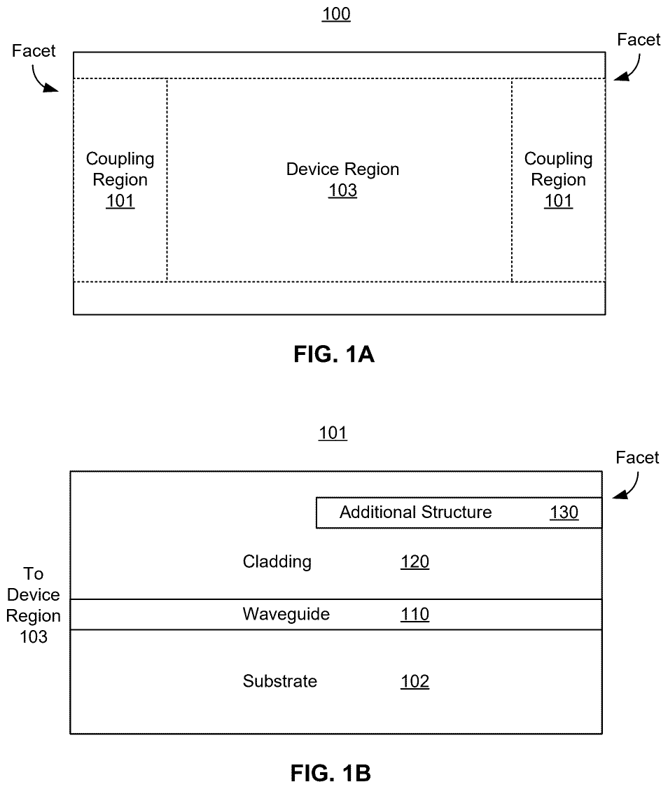

FIGS. 1A-1B are diagrams depicting an embodiment of photonics device 100 that may have improved optical coupling. FIG. 1A depicts a block diagram of photonics device 100, while FIG. 1B depicts a side/cross sectional view of a portion of photonics device 100. For clarity, not all components are depicted. Photonics device 100 is an optical device configured to transmit and operate on optical signals. Depending upon the application(s) for which photonics device 100 is used, various components may be included in photonics device 100. For example, waveguides 110, electrodes (not explicitly shown), mode and/or spot converters, polarization beam converters and/or other components may be included. In some embodiments, photodiodes and/or other components may be incorporated on photonics device 100. In some embodiments, photonics device 100 is a photonics integrated circuit (PIC).

Photonics device 100 includes coupling region 101 and device region 103. Coupling region 101 is used to couple optical signals (e.g., laser light and/or other modulated or unmodulated optical signals) into and/or out of photonics device 100. Device region 103 includes components that are used to operate on the optical signals. A portion of waveguide 110 is in device region 103 and carries an optical signal in device region 103. For example, waveguide 110 may have multiple arms used in, e.g., a Mach-Zehnder modulator in device region 103. Other configurations, other components, and other operations on the optical signal are possible. For example, device region 103 may configure the waveguide for mode conversion (e.g. TE to TM or a smaller, confined mode to a larger mode—otherwise known as spot size conversion), polarization rotation, and/or other functions. In some embodiments, waveguide 110 includes or consists of TFLC electro-optic material(s). For example, waveguide 100 may include or be made of TFLN and/or TFLT.

Coupling region 101 includes another portion of waveguide 110, cladding 120, and additional structure 130, shown in the side view of coupling region 101 in FIG. 1B. Also shown in FIG. 1B is substrate 102. Although not depicted, a buried oxide (BOX) layer or analogous layer(s) may be between waveguide 110 and substrate 102. Alternatively, such a BOX layer and/or other layers may be considered part of substrate 102. Cladding 120 may cover waveguide 110 and separate waveguide 110 from additional structure 130 as well as other structures. Although one additional structure 130 and waveguide 110 are shown, multiple additional structures and/or multiple waveguides may be present. In general, multiple additional structures 130 are present. Thus, coupling region 101 may include other components and/or may configure waveguide 110 for various functions. Although shown as having a constant thickness, in some embodiments, waveguide 110 may be tapered vertically (perpendicular to the interface with substrate 102), horizontally (in plane/parallel to the interface with substrate 102), and/or otherwise shaped. For example, waveguide 110 may become thinner and/or narrower closer to the facet. Thus, mode/spot size conversion and/or other conditioning of the optical mode may take place in coupling region 101. Similarly, although shown as having a constant thickness, the thickness width, and/or other features of additional structure 130 may vary.

Cladding 120 has a cladding index of refraction that is less than the index of refraction of waveguide 110. In some embodiments, cladding 120 includes or consists of SiO₂. Thus, waveguide 110 (e.g., a TFLN and/or TFLT waveguide) may confine the optical mode for the optical signal as desired. Additional structure 130 also has an index of refraction greater than the cladding index of refraction. For example, additional structure 130 may have an index of refraction of at least 2 and not more than 2.7. In some embodiments, additional structure(s) 130 may have an index of refraction less than that of cladding 120. Although shown extending above additional structure 130, in some embodiments, additional structure 130 is on cladding 120. In some embodiments, another layer may be on top of additional structure 130. Although shown as having a constant thickness, in some embodiments, the thickness of additional structure 130 may vary.

In the embodiment shown in FIG. 1B, waveguide 110 is closer to substrate 102 than additional structure 130. Additional structure 130 may be formed after waveguide 110. In some embodiments, additional structure 110 is formed from a passivation layer having a higher index of refraction than cladding 120. Such a passivation layer may be provided on cladding 120. For example, the passivation layer may be deposited on cladding 120 and a portion of the passivation layer may be removed. This may form an aperture in the passivation layer in coupling region 101. Some or all of additional structure 130 may be in this aperture. Thus, a portion of cladding 120 and/or other structures in coupling region 101 may be exposed by the passivation layer. However, part of the passivation layer extends into device region 103. A portion of waveguide 110 and other components in device region 103 may thus be sealed by the passivation layer. In some embodiments, the passivation layer, and thus additional structure 130, includes at least one of silicon nitride (SiN), silicon oxynitride, silicon dioxide, aluminum oxide, or aluminum nitride. The materials for such a passivation layer may provide hermetic sealing (e.g. against water vapor) and have a higher index of refraction than cladding 120, which may be or include SiO₂.

In some embodiments, the additional structure(s) 130 closest to waveguide 110 are at a distance of approximately one micrometer from waveguide 110. In some embodiments, additional structures(s) 130 are not more than three micrometers, not more than five micrometers, or not more than 10 micrometers from waveguide 110 from a top view (e.g. the horizontal distance in plane). In some embodiments, each additional structure 130 is a at distance of not more than three micrometers, not more than five micrometers, or not more than ten micrometers from a neighboring additional structure (not shown in FIG. 1). Other structures and/or numbers of structures may be used in some embodiments. The number and/or placement of the additional structure(s) 130 structures may depend upon the shape and/or characteristics of the mode desired.

In various embodiments, the length of additional structure 130 is at least ten micrometers, at least eighty micrometers and not more than one hundred and twenty micrometers, greater than one hundred micrometers, greater than two hundred micrometers, or greater than four hundred micrometers. The length of additional structure 130 may be desired to be sufficient to adiabatically couple the optical mode in waveguide 110 to additional structure(s) 130.

In various embodiments, the vertical distance between the additional structure 130 formed from a passivation layer and waveguide 130 is less than three micrometers, less than five micrometers, or less than seven micrometers. In some embodiments, the vertical distance between additional structure 130 and waveguide 110 is at least five hundred nanometers or at least one micrometer. The etch of the passivation layer forming additional structure(s) 130 may be able to resolve features with small enough critical dimension (CD) on the passivation layer. In some embodiments, the thickness and/or width (or other features) of the additional structure 130 may be controlled to be on the order of not more than one1 nanometer, not more than five nanometers, not more than ten nanometers, and less than forty nanometers.

In some embodiments, some or all of additional structure(s) 130 may be formed from the same material(s) as waveguide 110. For example, additional structure 130 may include or consist of TFLN and/or TFLT. In such embodiments, additional structure 130 may be adjacent to waveguide 110 and/or the same distance from substrate 102 as waveguide 110. For example, multiple additional structures 130 and waveguide 110 may form a trident or pentadent structure described herein. In such embodiments, additional structure(s) 130 may be termed additional waveguiding structures or waveguiding structures. In some such embodiments, both additional waveguiding structures and additional structure 130 further from substrate 102 than waveguide 110 may be present. In such embodiments, additional structure(s) 130 may be aligned with (e.g. vertically aligned) with waveguide 110 and the additional waveguiding structures. In some embodiments, additional structure 130 may be offset (e.g. not vertically aligned) from waveguide 110 and/or the additional waveguiding structures. Further, where multiple additional structures 130 are present, they need not be the same distance from substrate 102.

Photonic device 100 may have improved performance, robustness, and/or fabrication. Prior to etching, the TFLC layer from which waveguide 110 is formed may have a high nonuniformity. For example, the film thickness variation may be as high as ±50 nanometers. This may result in up to ±25% of film thickness variation for the TFLC electro-optic materials used in waveguide 110. Such variations may be problematic, particularly in coupling region 101 where waveguide 110 may be thinned. Materials used for the passivation layer, such as SiN, may be used for additional structure 130. Such materials are more easily deposited, etched, and patterned than TFLN and/or TFLT. This more easily fabricated material may be used to account for variations in the TFLC layer. Thus, issues with the nonuniformities in the TFLC electro-optic layer may be mitigated.

Optical device 100 may provide more efficient mode matching, for example to an optical fiber (not shown) which is desired to be optically coupled with photonics device 100. Additional structure(s) 130 have a higher index of refraction than cladding 120. In some embodiments, therefore, additional structure 130 may be used to engineer the index of refraction of the photonic device 100 (e.g. the distribution of the index of refraction throughout the device). In addition, additional structure 130 may be used to guide the optical mode for coupling to another component. Additional structure 130 may also reduce the mode overlap loss between waveguide 110 and optical fiber modes to below 1 dB/facet. Additional structure 130 may also allow more options for shaping the optical mode. If only waveguide 110 is used for mode shaping, then mode shaping is limited by geometric requirements for other components (e.g. components in device region 103). In embodiments including additional waveguiding structures, other conversions (e.g., between TE and TM) may be performed. Additional structures 130 further from substrate 102 than waveguide 110 may utilize a non-TFLC material, such as SiN or other material that can be easily deposited while having a higher index than the material used for cladding 120. The use of different materials may improve process yield. The use of multiple fine structures may also allow control of the TE and TM modes. Thus, additional structure 130 may reuse a portion of a readily fabricated layer (e.g. a passivation layer) that is used for hermetic sealing or passivation for the additional purpose guiding light and/or shaping the optical mode. Consequently, a low-loss spot size converter (or other device) that is tolerant of thickness variation in the TFLC layer used for waveguide 110 may be achieved. Performance may be improved by converting the mode with low loss. As indicated above, losses of below 1 dB per facet might be achieved.

Photonics device 100 may also be more robust against fabrication variations. Use of the passivation layer for multiple purposes (e.g. passivation/hermetic scaling particularly in device region 103 as well as improved conditioning of the mode using additional structure 130 for coupling out of photonics device 100) may reduce the cost and complexity of the fabrication process. This process may be significantly simpler than adding dedicated extra waveguiding layers. For example, the device can be made with at least one fewer mask because the existing passivation layer is also used for the mode conversion purpose. Stated differently, the existing passivation layer may be patterned without requiring additional masks and/or deposition of layers. Thus, performance and fabrication of photonics device 100 may be improved. Consequently, fabrication and performance of photonics device 100, both in relation to overall increased efficiency and also polarization-specific performance, may be improved.

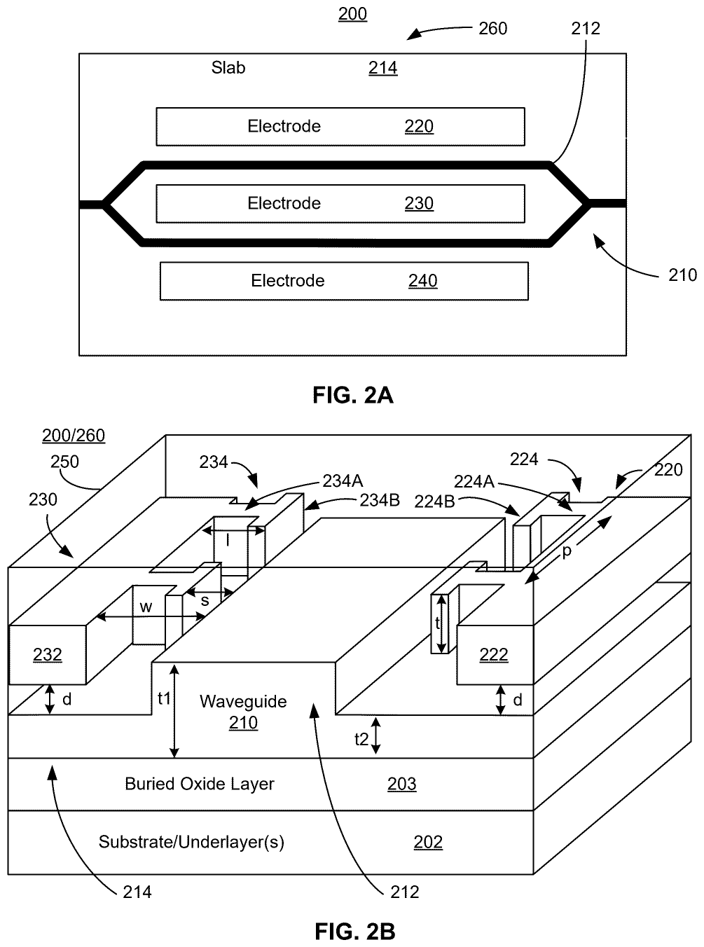

Device region 103 of photonics device 100 may perform various functions. In some embodiments, optical modulation may be performed. For example, FIGS. 2A-2B depict a portion of an embodiment of photonics device 200 using TFLC electro-optic material(s) and that may be part of photonics device 100. For example, photonics device 200 may be used as part or all of a modulator used in TFLC PIC 140. FIG. 2B is a perspective view of a portion of photonics device 200. FIGS. 2A-2B are not to scale. Only a portion of photonics device 200 is shown. Photonics device 200 may include other and/or additional structures that are not shown for simplicity. Further, although particular configurations are shown, other configurations are possible.

Photonics device 200 is on a substrate structure that includes substrate 202 and buried oxide (BOX) layer 203. In some embodiments, substrate 202 is a silicon substrate. Substrate 202 may also include other layers. In some embodiments, substrate 202 may be glass, quartz, silicon-on-insulator, and/or other low microwave loss dielectrics. Substrate 202 may be one hundred micrometers or more thick. BOX layer 203 may be a silicon dioxide layer. In some embodiments, BOX layer 203 may be at least three micrometers thick and not more than fifteen micrometers thick. In some embodiments, the substrate structure may be configured differently. Also shown is cladding 250, which may be formed of silicon dioxide.

Photonics device 200 includes waveguide 210 and electrodes 220, 230, and 240. In some embodiments, photonics device 200 may be configured as or include a modulator (or portion thereof). Thus, photonics device 200 may be considered to include modulation region 260. Other regions, such as a bend region, may be present. Modulator 200 is shown as configured as a Mach-Zehnder modulator. Other configurations for phase and/or amplitude modulation are possible. For clarity, only the portion of electrodes 220, 230, and 240 proximate to waveguide 210 are shown. Stated differently, electrodes 220, 230, and 240 are shown in modulation region 260.

Waveguide 210 may be considered to include ridge 212 as well as slab 214. Ridge 212 has a height, t1, greater than the height, t2, of slab 214. Although shown as rectangles, ridge 212 and/or slab 214 have other shapes, such as trapezoids and/or other analogous shapes. In addition, slap 212 may terminate closer to ridge 214 than at least a portion of electrode(s) 220 and/or 230. Photonics device 200 includes electro-optic optic material(s), such as TFLC materials (e.g. TFLN and/or TFLT). More specifically, ridge 212 and slab 214 include electro-optic materials, such as TFLC materials. In some embodiments, the waveguide 210 consists of TFLC materials such as TFLN and/or TFLT. In the embodiment shown, ridge 212 and slab 214 are formed of the same material. In some embodiments, ridge 212 and slab 214 may include different materials. Waveguide 210, and more particularly ridge 212, may be used to propagate the optical signal. The optical mode may be well confined to ridge 212 and/or ridge 212 in combination with a portion of nearby slab 214. Slab 214 provides increased electro-optic modulation efficiency. In particular, slab 214 aids in directing the electric field generated by the signal(s) in electrodes 220, 230, and 240 to optical mode 213 in modulation region 260. Thus, a higher modulation for a given electric field may be obtained. As a result, V-pi (and V-pi-L) may be reduced.

Electrodes 220, 230, and 240 may carry electrode signals used to modulate the optical signals (e.g. light) carried by waveguide 210 via electro-optic modulation. Electrode(s) 220 and/or 230 are configured to carry a traveling wave (e.g. a microwave or RF electrode signal) that modulates the optical signal carried by waveguide 210 via the electro-optic effect. For example, the electrode signals may provide electro-optic modulation up to frequencies of 100 GHz, 200 GHz, 500 GHZ or higher. In some embodiments, modulator 210 may provide modulation from at or near DC to frequencies of 100 GHz, 200 GHz, 500 GHZ, or more. The modulation may also have a wide window, for example an operation bandwidth of at least 20 GHz. Electrode signals carried by electrodes 220, 230, and 240 may be configured in a variety of manners. For example, electrode 230 may carry a microwave signal, while electrodes 220 and 240 are ground. Electrode 230 may carry a signal of a first polarity, while electrodes 220 and 240 carry signals of opposite polarity (i.e. in a differential configuration). Other configurations (including but not limited to another number of electrodes) are possible.

Electrodes 220, 230, and/or 240 may include extensions. Embodiments of analogous electrodes may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. In other embodiments, extensions may be omitted from some or all of electrodes 220, 230, and/or 240. Electrodes 220, 230, and 240 may carry differential electrical signals, a single electrical signal (e.g. a signal and ground), or other signal(s).

Electrode 230 includes a channel region 232 and extensions 234 (of which only one is labeled in FIG. 2B). Similarly, electrode 220 includes channel region 222 and extensions 224 (of which only one is labeled in FIG. 2B). In some embodiments, extensions 224 or 234 may be omitted from electrode 220 or electrode 230, respectively. Extensions 224 and 234 may be closer to ridge 212 than channel region 222 and 232, respectively, are. For example, the distance s from extensions 224 and 234 to waveguide ridge 212 is less than the distance w from channels 222 and 232 to waveguide ridge 212. Extensions 224 may be closer to electrode 230 (e.g. extensions 234 and/or channel 232) than channel 222 is. Similarly, extensions 234 may be closer to electrode 220 e.g. extensions 224 and/or channel 222) than channel 232 is.

Extensions 224 and 234 are in proximity to ridge 212. For example, extensions 224 and 234 are a vertical distance, d from slab 214 of TFLC waveguide 210. The vertical distance to TFLC waveguide 210 may depend upon the cladding 250 used. The distance d is highly customizable in some cases. For example, d may range from zero (or less if electrodes 220 and 230 contact or are embedded in slab portion 214) to greater than the height of ridge 212. In embodiments in which slab 214 terminates closer to ridge 212 than channel regions 222 and 232, d may be zero (same level as the top surface of slab 214), positive (further from substrate 202 than the top surface of slab 214), or negative (further from substrate 202 than the top surface of slab 214). However, d is generally still desired to be sufficiently small that electrodes 220 and 230 can apply the desired electric field to ridge 212. Extensions 224 and 234 are also a distance, s, from ridge 212. In some embodiments, s<0 (i.e., extensions 224 and/or 234 may extend over the top of ridge 212 or below waveguide 210). Extensions 224 and 234 are desired to be sufficiently close to TFLC waveguide 210 (e.g. close to ridge 212) that the desired electric field and index of refraction change can be achieved. However, extensions 224 and 234 are desired to be sufficiently far from TFLC waveguide 210 (e.g. from ridge 212) that their presence does not result in undue optical losses. Although shown next to ridge 212, extensions 224 and/or 234 may extend above and/or below ridge 212.

In the embodiment shown, extensions 224 have a connecting portion 224A and a retrograde portion 224B. Retrograde portion 224B is so named because a part of retrograde portion may be antiparallel to the direction of signal transmission through electrode 220. Similarly, extensions 234 have a connecting portion 234A and a retrograde portion 234B. Thus, extensions 224 and 234 have a “T”-shape. In some embodiments, other shapes are possible. For example, extensions 224 and/or 234 may have an “L”-shape, may omit the retrograde portion, may be rectangular, trapezoidal, parallelogram-shaped, may partially or fully wrap around a portion of ridge 212, and/or have another shape. Similarly, channel regions 222 and/or 232, which are shown as having a rectangular cross-section, may have another shape. Further, extensions 224 and/or 234 may be different sizes. Although all extensions 224 and 234 are shown as the same distance from ridge 212, some of extensions 224 and/or some of extensions 234 may be different distances from ridge 212. Channel regions 222 and/or 232 may also have a varying size.

Also indicated in FIG. 2B is thickness, t, of extensions 224 and 234. In the embodiment shown, channels 222 and 232 have the same thickness. In some embodiments, the thickness of extensions 224 and/or 234 may vary. For example, extensions 224 may be thinner (or thicker) than extensions 234. Further, different extensions 224 may have different thicknesses. Similarly, different extensions 234 may have different thicknesses. Extensions 224 and/or 234 may also have a different thickness than channels 222 and/or 232. For example, extensions 224 and/or 234 may be thinner (or thicker) than channels 222 and/or 232. Different portions of extensions 224 and/or 234 may also have different thicknesses. For example, retrograde portions 224B and/or 234B may be thinner (or thicker) than connecting portions 224A and/or 234B. Thus, TFLC PICs 200 and 140 may have a variety of configurations, components, and functions. Performance of TFLC PICs 200 and 140 may be superior to that of other, non-TFLC PICS.

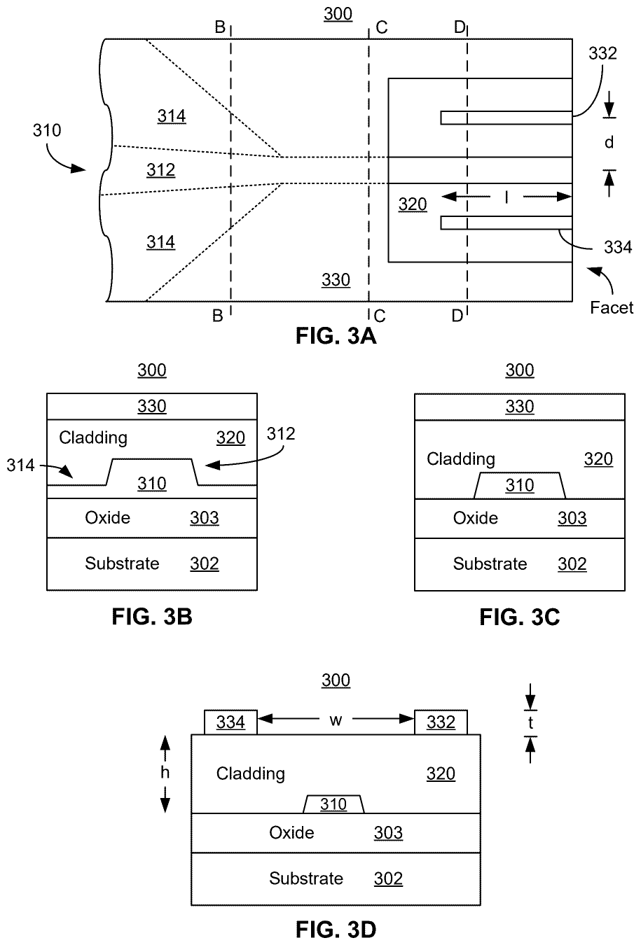

FIGS. 3A-3D depict an embodiment of photonics device 300 that may have improved optical coupling. FIG. 3A depicts a top view of a portion of photonics device 300, while FIGS. 3B, 3C, and 3D depicts cross sectional views of photonics device 300 along lines B-B, C-C, and D-D shown in FIG. 3A. For clarity, not all components are depicted. Photonics device 300 is analogous to photonics device 100. Thus, photonics device 300 includes waveguide 310, substrate 302, cladding 320, and additional structures 332 and 334 that are analogous to waveguide 110, substrate 102, cladding 120, and additional structure 130. Photonics device 300 also includes a device portion and coupling portion proximate to the facet. For example, in addition to waveguide 310, electrodes (not explicitly shown) and/or other components may be included in the device portion of photonics device 300. Also shown is oxide 303 that may be a BOX layer.

Waveguide 310 includes slab 314 and ridge 312 in some regions. In the embodiment shown, waveguide 310 is tapered closer to the facet. Thus, the width and, in some embodiments, height of waveguide 310 may be reduced proximate to the facet. Thus, waveguide 310 may be configured to increase the mode size proximate to the facet. This may be considered part of a spot converter for coupling the optical signal in waveguide 310 with an optical fiber (not shown) or other optical component off-chip. In the embodiment shown, waveguide 310 extends to the facet of photonics device 300. In some embodiments, waveguide 310 is recessed from the facet.

Photonics device 300 also passivation layer 330. Passivation layer 330 is used to hermetically seal the device portion of photonics device 300. Thus, the device portion of photonics device 300 may be protected from the ambient, water, and other elements that can damage the device. Passivation layer 330 includes aperture in which additional structures 332 and 334 are formed. The aperture is proximate to the facet in some embodiments. Passivation layer 330 is thus removed for a portion the coupling region of photonics device 300. In some embodiments, cladding 320 is exposed by the aperture. Although termed an aperture, the region at which passivation layer 330 may include an edge of photonics device 300. More specifically, passivation layer 330 may be removed for the spot size converter (also called an off-chip coupler section, edge coupler, or mode converter) of photonics device 300. The spot size converter may be the final part of photonics device 300 through which light travels before the light exits photonics device 300. The aperture in passivation layer 330 may reduce negative performance effects that occur if the entire hermetic, passivation layer 300 is present over the spot size converter. For example, keeping the entirety of passivation layer 300 may be suboptimal for waveguiding or optical mode matching. Although the aperture is formed in passivation layer 330, in some embodiments, an epoxy or other material may encapsulate or hermetically seal photonics device 300 (e.g. covering additional structures 332 and 334 and cladding 320 exposed in the aperture) despite the removal of the portion of passivation layer 330.

Additional structures 332 and 334 may be formed by etching the aperture into passivation layer 330. Additional structures 332 and 334 are portions of passivation layer 330 that remain in the aperture in passivation layer 330 after the etch. Passivation layer 330 and additional structures 332 and 334 thus have a higher index of refraction than cladding 320. Structures 330, 332, and 334 may include one or more of silicon nitride, silicon oxynitride, silicon dioxide, aluminum oxide, or aluminum nitride. For example, passivation layer 330 and additional structures 332 and 334 may have an index of refraction of at least 2 and not more than 2.7. In contrast, cladding 320 may have an index of refraction of at least 1.4 and not more than approximately 1.5. In some embodiments, therefore, additional structures 332 and 334 are not TFLC electro-optic materials.

In some embodiments, passivation layer 330 (and thus additional structures 332 and 334) have a thickness, t, of at least five nanometers and not more than two hundred nanometers. In some embodiments, t is at least fifty nanometers. In some embodiments, the horizontal distance, d, between additional structures 332 and/or 334 and waveguide 310 is approximately one micrometer (e.g. at least eight hundred nanometers and not more than 1.2 micrometers). In some embodiments, this distance d is not more than three micrometers, not more than five micrometers, or not more than ten micrometers. In some embodiments, each additional structure 332 or 334 is a distance, w, from a neighboring additional structure 334 or 332. In some embodiments, w is not more than three micrometers, not more than five micrometers, or not more than ten micrometers. The vertical distance, h, between passivation layer 330 (and thus passivation structures 332 and 334) and waveguide 310 is less than seven micrometers in some embodiments. In some embodiments, h is less than five micrometers or less than three micrometers. In some embodiments, the h is at least one micrometer. In various embodiments, the length, 1, of an additional structure 332 and/or 334 is at least ten micrometers, at least eighty and not more than one hundred twenty micrometers, greater than 100 micrometers, greater than 200 micrometers, or greater than 400 micrometers. The length of additional structures 332 and 334 may be configured to be sufficiently large to adiabatically couple the optical mode in the TFLC waveguide to the passivation structure. Other structures and/or numbers of additional structures may be used in some embodiments. The number and/or placement of additional structures 332 and 334 may depend upon the shape and/or characteristics of the mode desired. Further, although shown as substantially constant in width and height, additional structures 332 and/or 334 may have a varying width and/or height.

The etch of passivation layer 330 (which also forms additional structures 332 and 334) may be able to resolve features with small enough critical dimension (CD) on the passivation layer. In some embodiments, the thickness and/or width of additional structures 332 and/or 332 (or other features) of passivation layer 330 may be controlled to be on the order of not more than one nanometer, not more than five nanometers, not more than ten nanometers, and less than forty nanometers. Thus, the width of additional structures 332 and/or 334 may be as low as the CD for etches of passivation layer 330.

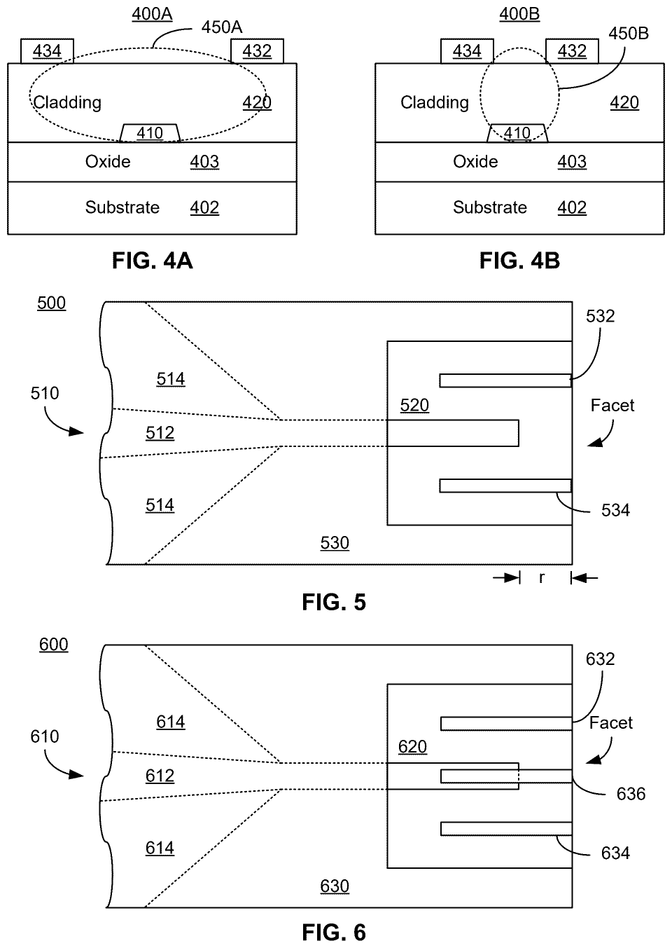

In operation, the mode (or spot size) is expanded proximate to the facet of photonics device 300. Photonics device 300 allows controlled and efficient mode matching. In addition to tapering of waveguide 310, additional structures 332 and 334 may support the expanded mode (or spot) size. More specifically, additional structures 332 and 334 may guide the optical mode as well as configure the shape of the optical mode. This may be seen with respect to FIGS. 4A and 4B.

FIGS. 4A-4B depict embodiments of photonics devices 400A and 400B that may have improved optical coupling and are analogous to photonics device 300. Photonics devices 400A and 400B thus include substrate 402, oxide 403, waveguide 410, cladding 420, and additional structures 432 and 434 that are analogous to substrate 302, oxide 303, waveguide 310, cladding 320, and additional structures 332 and 334, respectively. However, additional structures 432 and 434 are spaced further apart and further from waveguide 410 in photonics device 400A than in photonics device 400B. Consequently, the optical mode 450A in photonics device 400A is wider (e.g. a more eccentric ellipse) than optical mode 450B in photonics device 400B. Use of additional structures 332 and 334 (as well as 432 and 434) may, therefore, improve control over the mode in the coupling region.

Referring back to FIGS. 3A-3D, additional structures 332 and 334 are formed of a non-TFLC material that may be easily deposited and etched, while having a higher index than cladding 320. Additional structures 332 and 334 thus improve control over the optical mode in the coupling region and may reduce optical losses. The use of different materials (e.g., TFLC for waveguide 310 and the material used for passivation layer 330 and additional structures 332 and 334) improves process yield. Additional structures 332 and 334 may also be used to compensate for variations in the thickness of waveguide 310. Removal of most of passivation layer 330 in the aperture may improve optical coupling between waveguide 310 and the component (e.g. an optical fiber) with which photonics device 310 is desired to be coupled.

Photonics device 300 may thus share the benefits of photonics device 100. By reusing a layer 330/332/334 that is used for hermetic sealing or passivation for the additional purpose of guiding light and shaping the optical mode, a low-loss spot size converter (or other device) that is tolerant of thickness variation in the TFLC layer may be achieved. More specifically, materials used for passivation layer 330 (and thus additional structures 332 and 334) may be simpler to fabricate and have more readily controllable thicknesses than TFLC electro-optic materials. Such materials may be deposited or grown with relatively small thickness variation compared to TFLC electro-optic materials. By leveraging passivation layer 330, via structures 332 and 334, for optical waveguiding, the performance of photonics device 300 may be less sensitive to TRLC material thickness variation. By increasing the robustness of photonics device 300 to thickness variation, the yield of PICs such as photonics device 300 may be increased.

Performance of photonics device 300 may be improved by converting the mode with low loss. In some embodiments, the mode overlap loss between waveguide(s) 310 and modes for an optical fiber (not shown) coupled at the facet may be below 1 dB/facet. Moreover, photonics device 300 (as indicated by photonics devices 400A and 400B) may allow more shaping of the mode. The use of additional structures 332 and 334 may allow low-loss mode matching between photonics device 300 and external elements such as a fiber with a specific mode. The mode may thus be engineered to match closely with that of the external element. Additional structures 332 and 334 may be engineered to facilitate the shape of the TE or TM mode and optimize for polarization. Thus, additional structures 332 and 334 may increase the parameter space, allowing polarization optimization.

Photonics device 300 may thus have improved performance and be more robust against fabrication variations. Cost and complexity of the fabrication process may also be reduced as compared to the use of dedicated extra laminated waveguide layers. For example, photonics device 300 can be made using at least one fewer mask because existing passivation layer 330 (via additional structures 332 and 334) is used for the mode conversion purpose. Stated differently, existing passivation layer 330 may be patterned without requiring additional masks and/or deposition of layers. Thus, fabrication and performance of TFLC photonics device 300 may be improved.

FIG. 5 depicts an embodiment of photonics device 500 that may have improved optical coupling. FIG. 5 depicts a top view of a portion of photonics device 500. Photonics device 500 is analogous to photonics devices 100 and 300. Thus, photonics device 500 includes waveguide 510, substrate (not shown), cladding 520, passivation layer 530, and additional structures 532 and 534 that are analogous to waveguide 110/310, substrate 102/302, cladding 120/320, passivation layer 330, and additional structures 130/332 and 334. Photonics device 500 also includes a device portion and coupling portion proximate to the facet. For example, in addition to waveguide 510, electrodes (not explicitly shown) and/or other components may be included in the device portion of photonics device 500. In the embodiment shown, waveguide 510 is recessed from the facet.

Photonics device 500 functions in an analogous manner to photonics devices 300 and 100. Photonics device 500 may thus share the benefits of photonics devices 100 and/or 300. For example, photonics device 500 may be more robust against thickness variations in the TFLC material(s) used for waveguide 510, may have reduced optical coupling losses, and/or improved control over the optical mode.

FIG. 6 depicts an embodiment of photonics device 600 that may have improved optical coupling. FIG. 6 depicts a top view of a portion of photonics device 600. Photonics device 600 is analogous to photonics devices 100 and 300. Thus, photonics device 600 includes waveguide 610, substrate (not shown), cladding 620, passivation layer 630, and additional structures 632 and 634 that are analogous to waveguide 110/310, substrate 102/302, cladding 120/320, passivation layer 330, and additional structures 130/332 and 334. Photonics device 600 also includes a device portion and a coupling portion proximate to the facet. For example, in addition to waveguide 610, electrodes (not explicitly shown) and/or other components may be included in the device portion of photonics device 600. In the embodiment shown, waveguide 610 is recessed from the facet. In addition, another additional structure 636 is shown. Additional structure 636 is analogous to structures 632 and 634 and formed from passivation layer 630. The use of more additional structures 632, 634, and 636 may improve control over the optical mode. For example, the shape of the optical mode may be further controlled.

Photonics device 600 functions in an analogous manner to photonics devices 300 and 100. Photonics device 600 may thus share the benefits of photonics devices 100 and/or 300. For example, photonics device 600 may be more robust against thickness variations in the TFLC material(s) used for waveguide 610, may have reduced optical coupling losses, and/or improved control over the optical mode.

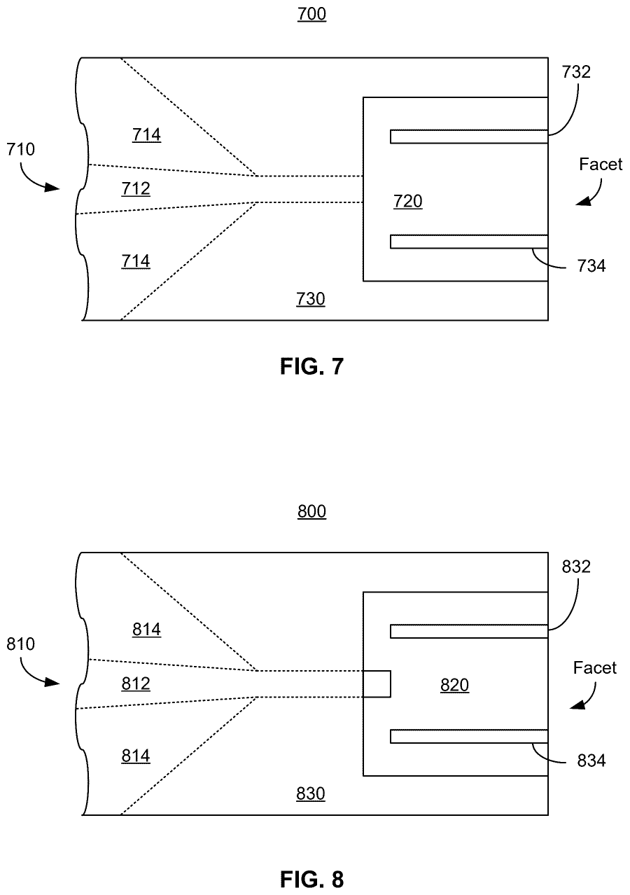

FIG. 7 depicts an embodiment of photonics device 700 that may have improved optical coupling. FIG. 7 depicts a top view of a portion of photonics device 700. Photonics device 700 is analogous to photonics devices 100 and 300. Thus, photonics device 700 includes waveguide 710, substrate (not shown), cladding 720, passivation layer 730, and additional structures 732 and 734 that are analogous to waveguide 110/310, substrate 102/302, cladding 120/320, passivation layer 330, and additional structures 130/332 and 334. Photonics device 700 also includes a device portion and coupling portion proximate to the facet. For example, in addition to waveguide 710, electrodes (not explicitly shown) and/or other components may be included in the device portion of photonics device 700. In the embodiment shown, waveguide 710 is further recessed from the facet. Waveguide 710 is also recessed from the ends of additional structures 732 and 734.

Photonics device 700 functions in an analogous manner to photonics devices 300 and 100. Photonics device 700 may thus share the benefits of photonics devices 100 and/or 300. For example, photonics device 700 may be more robust against thickness variations in the TFLC material(s) used for waveguide 710, may have reduced optical coupling losses, and/or improved control over the optical mode.

FIG. 8 depicts an embodiment of photonics device 80 that may have improved optical coupling. FIG. 8 depicts a top view of a portion of photonics device 800. Photonics device 800 is analogous to photonics devices 100 and 300. Thus, photonics device 800 includes waveguide 810, substrate (not shown), cladding 820, passivation layer 830, and additional structures 832 and 834 that are analogous to waveguide 110/310, substrate 102/302, cladding 120/320, passivation layer 330, and additional structures 130/332 and 334. Photonics device 800 also includes a device portion and coupling portion proximate to the facet. For example, in addition to waveguide 810, electrodes (not explicitly shown) and/or other components may be included in the device portion of photonics device 800. In the embodiment shown, waveguide 810 is recessed from the facet. However, waveguide 810 terminates closer to the additional structures 832 and 834.

Photonics device 800 functions in an analogous manner to photonics devices 300 and 100. Photonics device 800 may thus share the benefits of photonics devices 100 and/or 300. For example, photonics device 800 may be more robust against thickness variations in the TFLC material(s) used for waveguide 810, may have reduced optical coupling losses, and/or improved control over the optical mode.

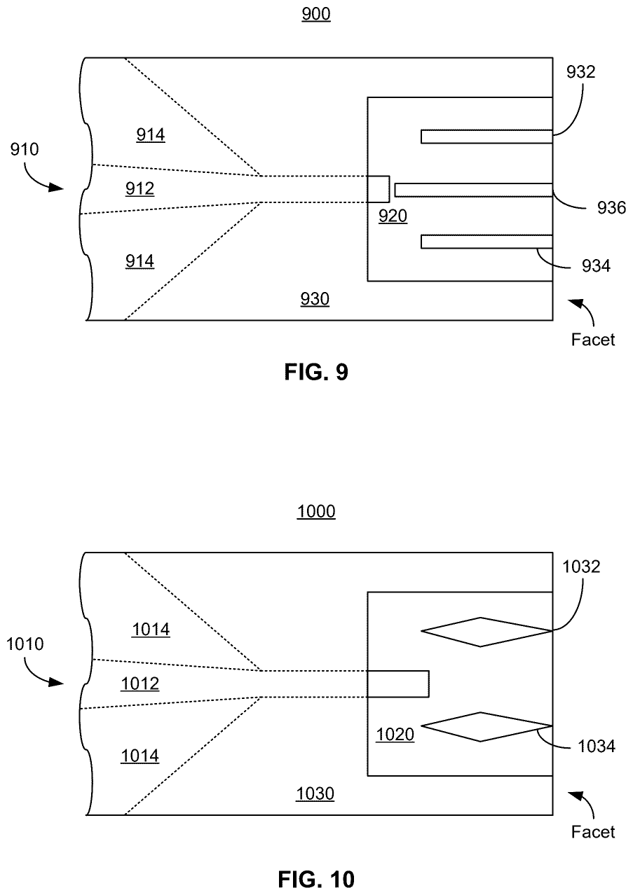

FIG. 9 depicts an embodiment of photonics device 900 that may have improved optical coupling. FIG. 9 depicts a top view of a portion of photonics device 900. Photonics device 900 is analogous to photonics devices 100 and 300. Thus, photonics device 900 includes waveguide 910, substrate (not shown), cladding 920, passivation layer 930, and additional structures 932 and 934 that are analogous to waveguide 110/310, substrate 102/302, cladding 120/320, passivation layer 330, and additional structures 130/332 and 334. Photonics device 900 also includes a device portion and coupling portion proximate to the facet. For example, in addition to waveguide 910, electrodes (not explicitly shown) and/or other components may be included in the device portion of photonics device 900. In the embodiment shown, waveguide 910 is recessed from the facet. Further, another additional structure 936 is included. The lengths of additional structures 932 and 934 differ from the length of additional structure 936.

Photonics device 900 functions in an analogous manner to photonics devices 300 and 100. Photonics device 900 may thus share the benefits of photonics devices 100 and/or 300. Greater control over the shape of the optical mode may be achieved using another additional structure 936. For example, photonics device 900 may be more robust against thickness variations in the TFLC material(s) used for waveguide 910, may have reduced optical coupling losses, and/or improved control over the optical mode.

FIG. 10 depicts an embodiment of photonics device 1000 that may have improved optical coupling. FIG. 10 depicts a top view of a portion of photonics device 1000. Photonics device 1000 is analogous to photonics devices 100 and 300. Thus, photonics device 1000 includes waveguide 1010, substrate (not shown), cladding 1020, passivation layer 1030, and additional structures 1032 and 1034 that are analogous to waveguide 110/310, substrate 102/302, cladding 120/320, passivation layer 330, and additional structures 130/332 and 334. Photonics device 1000 also includes a device portion and coupling portion proximate to the facet. For example, in addition to waveguide 1010, electrodes (not explicitly shown) and/or other components may be included in the device portion of photonics device 1000. In the embodiment shown, waveguide 1010 is recessed from the facet. In addition, the width of additional structures 1032 and 1034 varies. Consequently, additional structure may have shapes other than that of a rectangle.

Photonics device 1000 functions in an analogous manner to photonics devices 300 and 100. Photonics device 1000 may thus share the benefits of photonics devices 100 and/or 300. For example, photonics device 1000 may be more robust against thickness variations in the TFLC material(s) used for waveguide 1010, may have reduced optical coupling losses, and/or improved control over the optical mode.

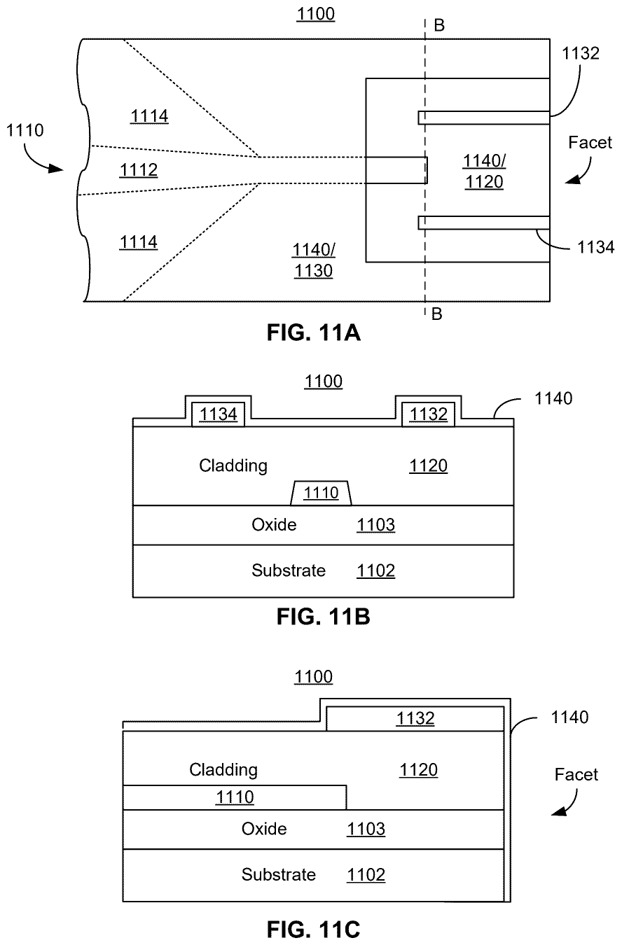

FIGS. 11A-11C depict an embodiment of a photonics device that may have improved optical coupling. FIG. 11A depicts a top view of a portion of photonics device 1100. FIG. 11B depicts a cross-sectional view of photonics device 1100 along line B-B. FIG. 11C depicts a side cross-sectional view of photonics device 1100. Photonics device 1100 is analogous to photonics devices 100 and 300. Thus, photonics device 1100 includes waveguide 1110, substrate (not shown), cladding, passivation layer 1130, and additional structures 1132 and 1134 that are analogous to waveguide 110/310, substrate 102/302, cladding 120/320, passivation layer 330, and additional structures 130/332 and 334. Photonics device 1100 also includes a device portion and coupling portion proximate to the facet. For example, in addition to waveguide 1110, electrodes (not explicitly shown) and/or other components may be included in the device portion of photonics device 1100. In the embodiment shown, waveguide 1110 is recessed from the facet. Waveguide 1110 also extends past the end of additional structures 1132 and 1134.

In the embodiment shown, photonics device 1100 includes an additional layer 1140. Additional layer 1140 may be used to encapsulate photonics device 1100. In the embodiment shown, additional passivation layer 1140 extends to encapsulate the facet. However, in other embodiments, additional passivation layer 1140 may not cover the facet. In some embodiments, additional passivation layer 1140 may be an epoxy. Other and/or additional materials may be used. For example, materials such as Si, Si₃N₄, SiO₂, SiONₓ (silicon oxynitride) might be used in additional passivation layer 1140. Thus, additional passivation layer 1140 may be deposited on previously exposed region(s) to achieve improved encapsulation. In some embodiments, additional passivation layer 1140 may have a thickness of at least five nanometers and not more than two hundred nanometers. Other thicknesses and/or other materials may be used. In some embodiments, additional passivation layer 1140 may be a multilayer stack.

Photonics device 1100 functions in an analogous manner to photonics devices 300 and 100. Photonics device 1100 may thus share the benefits of photonics devices 100 and/or 300. For example, photonics device 1100 may be more robust against thickness variations in the TFLC material(s) used for waveguide 1110, may have reduced optical coupling losses, and/or improved control over the optical mode. Photonics device 1100 may also have improved protection due to layer 1140.

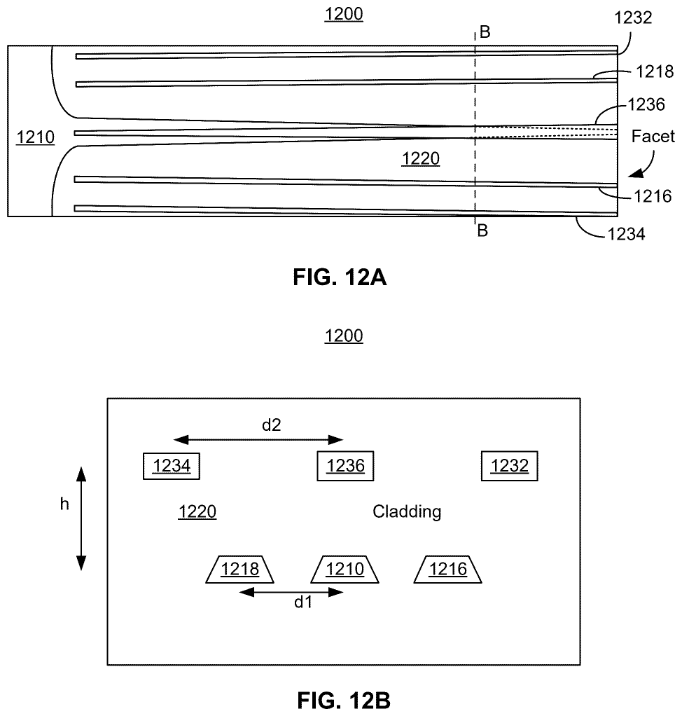

FIGS. 12A-12B depict an embodiment of a photonics device that may have improved optical coupling. FIG. 12A depicts a top view of a portion of photonics device 1200. FIG. 12B depicts a cross-sectional view along line B-B. Photonics device 1200 is analogous to photonics devices 100 and 300. Thus, photonics device 1200 includes waveguide 1210, substrate (not shown), cladding 1220, passivation layer 1230, and additional structures 1232 and 1234 that are analogous to waveguide 120/310, substrate 102/302, cladding 120/320, passivation layer 330, and additional structures 130/332 and 334. Photonics device 1200 also includes a device portion and coupling portion proximate to the facet. For example, in addition to waveguide 1210, electrodes (not explicitly shown) and/or other components may be included in the device portion of photonics device 1200. Photonics device also includes another additional structure 1236 analogous to additional structures 1232 and 1234.

In addition, photonics device 1200 includes additional waveguiding structures 1216 and 1218. Additional waveguiding structures 1216 and 1218 are approximately the same distance from the underlying substrate (not shown) as waveguide 1210. Thus, waveguiding structures 1216 and 1218 may be in the same layer as and adjacent to waveguide 1210. Waveguiding structures 1216 and 1218 may be TFLC structures. Thus, waveguiding structures 1216 and 1218 may be analogous to waveguide 1210 and may be formed during fabrication of waveguide 1210. In some embodiments, only central waveguide 1210 is formed of TFLC electro-optic materials. In such embodiments, additional waveguiding structures 1216 and 1218 may be formed of materials having a higher index of refraction than cladding 1220. The materials may have an index of refraction similar to the waveguide index of refraction for waveguide 1210. For example, silicon, silicon nitride, silicon dioxide, silicon oxynitride, aluminum oxide, and/or aluminum nitride may be used.

Photonics device 1200 uses additional structures 1232, and 1234, 1236 in combination with additional waveguiding structures 1216 and 1218 to expand the optical mode. The optical mode may be expanded into a more symmetric mode shape to match the mode of an external element (e.g. a fiber). The more symmetric mode shape is facilitated by the use of two layers (structures 1216 and 1218 and structures 1232, 1234, and 1236) of structures that aid in stretching the mode. The symmetry allows a mode with symmetric power throughout the mode. In some embodiments, an asymmetric mode may be achieved if desired. Moreover, other and/or more structures analogous to structures 1216, 1218, 1232, 1234, and/or 1236 may be used. In some embodiments, the mode may be stretched to a circular shape having a diameter of at least five micrometers, greater than seven micrometers, greater than ten micrometers, or greater than fifteen micrometers. In some embodiments, the circular mode is not more than twenty micrometers in diameter. Other shapes and/or sizes may be achieved.

In some embodiments, the distance, d2, between additional structures 1232, 1234, and 1236 is greater than one micrometer, greater than two micrometers, greater than three micrometers, or greater than five micrometers. In some embodiments, the distance between additional structures 1232, 1234, and 1236 is not more than ten micrometers. In some embodiments, the vertical distance, h, between the structures 12232, 1234, and 1236 and structures 1218 and 1216 is greater than one micrometer, greater than two micrometers, greater than three micrometers, or greater than five micrometers. The vertical distance may also be less than ten micrometers or less than fifteen micrometers. For example, h may be at least two micrometers and not more than 3.5 micrometers. The distance, h, may depend on performance requirements of other components on the photonics device 1200. For example, if other components are tolerant of a larger distance, then h may be increased. The distance h also varies based on the desired mode shape. In some embodiments, the distance from the top of waveguide 1210 in this region to the top of photonics device 1200 is less than five micrometers, less than seven micrometers, less than ten micrometers, or less than fifteen micrometers. Other distances are possible.

Photonics device 1200 functions in an analogous manner to photonics devices 300 and 100. Photonics device 1200 may thus share the benefits of photonics devices 100 and/or 300. For example, photonics device 1200 may be more robust against thickness variations in the TFLC material(s) used for waveguide 1210, may have reduced optical coupling losses, and/or improved control over the optical mode.

In addition, a symmetric mode may be output by photonics device 1200. A symmetric mode shape may provide better coupling efficiency in some cases. Coupling efficiency is calculated using the two dimensional overlap integral of two modes (e.g. of the PIC and the external element, such as a fiber). To optimize coupling to the external element, the mode at the edge of photonics device 1200 may be desired to be close to the shape, size, and symmetry of the external element mode. A fiber mode may be symmetric and circular. The shape of the mode for photonics device 1200 may be configured using the distances (e.g. d1, d2, and h) as well as the refractive indices. The materials are used in the structures 1232, 1234, and 1236 may be different from the materials in 1218 and 1216 (and in some embodiments 1210). The refractive indices of the materials, while similar, may not be exactly the same. For example, the material indices of TFLN and SiN are different. Using the dimensions and materials, additional structures 1232, 1234, and 1236 and waveguiding structures 1216 and 1218 may be engineered in order to cause the effective refractive indices of the TFLC and SiN structures to be the same or very close. For example, the width, thickness, other dimensions, and locations of the side arms (e.g. the structures 1234 and 1232 or the structures 1216 and 1218 that are to the sides of the center band) are adjusted. Matching the refractive indices of structures 1232, 1234, and 1236 with the refractive indices of structures 1210, 1216, and 1218 may allow the mode to match without requiring a long distance. This may save space for PIC 1200. Thus, performance of photonics device 1200 may be further improved.

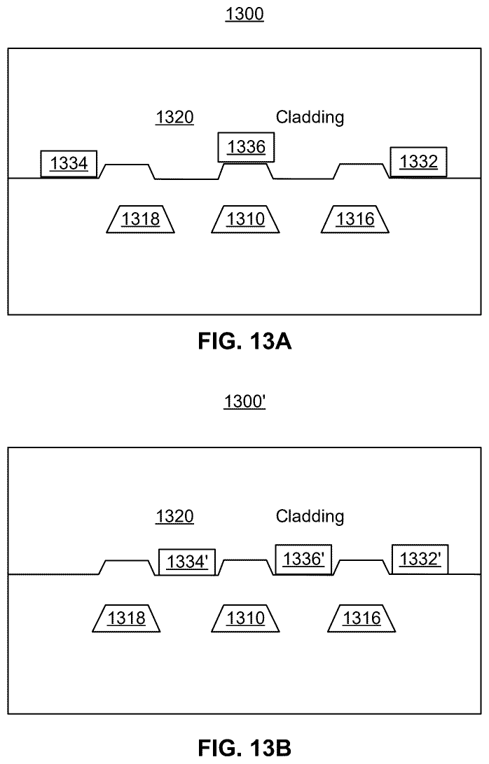

FIGS. 13A-13B depict embodiments of photonics devices 1300 and 1300′ that may have improved optical coupling. FIGS. 13A and 13B depict cross-sectional views of a portion of photonics devices 1300 and 1300′. Photonics device 1300 is analogous to photonics devices 100, 300, and 1200. Thus, photonics device 1300 includes waveguide 1310, substrate (not shown), cladding 1320, passivation layer 1330, additional structures 1332, 1334, and 1336 and waveguiding structures 1316 and 1318 that are analogous to waveguide 130/310/1210, substrate 102/302, cladding 130/320/1220, passivation layer 330, and additional structures 130/332 and 334/1232, 1234, and 1236 and waveguiding structures 1216 and 1218. Photonics device 1300 also includes a device portion and coupling portion proximate to the facet. For example, in addition to waveguide 1310, electrodes (not explicitly shown) and/or other components may be included in the device portion of photonics device 1300.

In photonics device 1200, additional structures 1232, 1234, and 1236 are provided on a flat layer. For example, cladding 1220 may be planarized after formation of waveguide 1210 and waveguiding structures 1216 and 1218. TFLC materials are difficult to provide in a completely flat layer. Moreover, even a flat TFLC layer is patterned into structures 1310, 1316, and 1318. Cladding 1220 and 1320, which may be a thick oxide, is utilized on top of the TFLC structures. This creates a non-flat surface for the thick oxide indicated in photonics devices 1300 and 1300′. This topology makes it challenging to align the second layer structures (i.e. additional structures 1332, 1334, 1336, 1332′, 1334′, and 1336′) with waveguide 1310 and additional waveguiding structures 1316 and 1318 if cladding 1320 is not planarized.

In photonics devices 1300 and 1300′, the uneven surface of the cladding 1320 is factored into photonics devices 1300 and 1300′. For example, scanning electron microscopy (SEM) can be used to identify flat or uneven sections given a specific mask pattern used. The upper additional structures are placed accordingly. For photonics device 1300, central structure 1336 is aligned with waveguide 1310. Thus, additional structure 1336 is slightly higher. Additional structures 1334 and 1336 may be placed further outside of the uneven surface. In contrast, in photonics device 1300′, additional structures 1332′, 1334′, and 1336′ are shifted slightly. As a result, additional structures 1332′, 1334′, and 1336′ are vertically aligned. Thus, additional structures 1332, 1334, 1336, 1332′, 1334′, and/or 1336′ are placed to account for thickness variations. In some embodiments, additional structures 1332′, 1334′, and 1336′ may be shifted by at least four hundred nanometers, at least five hundred nanometers, and at least six hundred nanometers and not more than one micrometer without incurring significant losses. Thus, the bilayer trident structure of photonics device 1300 may be tolerant of misalignments. The shape of the optical mode may still be optimized.

Photonics devices 1300 and 1300′ function in an analogous manner to photonics devices 300, 100, and 1200. Photonics devices 1300 and 1300′ may thus share the benefits of photonics devices 100, 300, and/or 1200. For example, photonics devices 1300 and 1300′ may be more robust against thickness variations in the TFLC material(s) used for waveguide 1310, may have reduced optical coupling losses, and/or improved control over the optical mode (e.g., may provide a more symmetric mode).

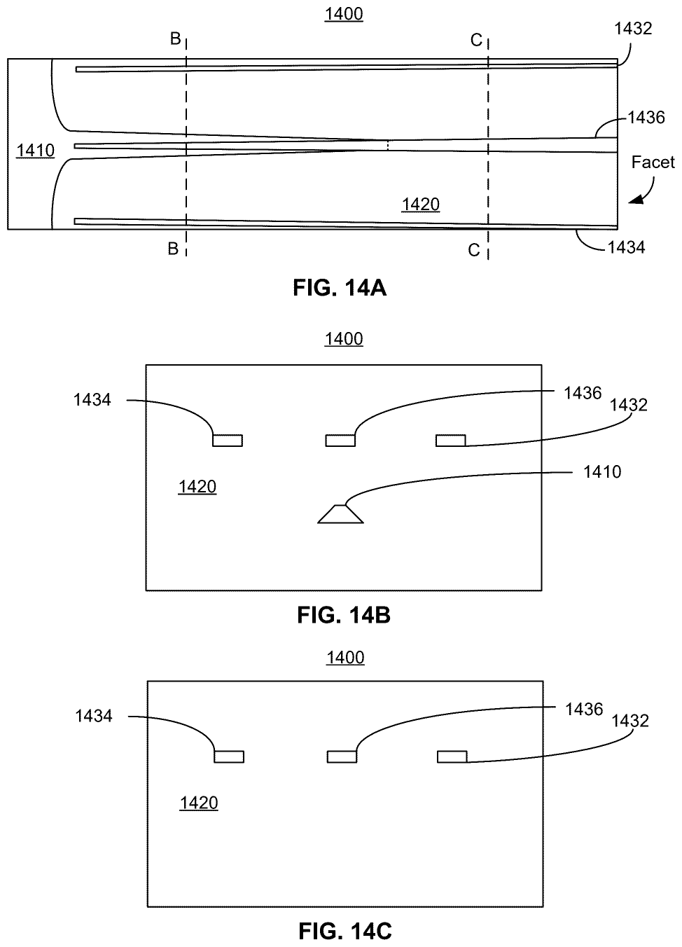

FIGS. 14A-14C depict an embodiment of photonics device 1400 that may have improved optical coupling. FIG. 14A depicts a top view of photonics device 1400. FIGS. 14B and 14C depict cross-sectional views of photonics device 1400 at lines B-B and C-C. Photonics device 1400 is analogous to photonics devices 100, 300, 1200, and 1300. Thus, photonics device 1400 includes waveguide 1410, substrate (not shown), cladding 1420, passivation layer 1430, additional structures 1432, 1434, and 1436 and waveguiding structures 1416 and 1418 that are analogous to waveguide 140/310/1210, substrate 102/302, cladding 140/320/1220, passivation layer 330, and additional structures 140/332 and 334/1232, 1234, and 1236 and waveguiding structures 1216 and 1218. Photonics device 1400 also includes a device portion and coupling portion proximate to the facet. For example, in addition to waveguide 1410, electrodes (not explicitly shown) and/or other components may be included in the device portion of photonics device 1400. In the embodiment shown, waveguide 1410 is recessed from the facet.

However, photonics device 1400 includes only central waveguide 1410 in the lower layer. Waveguide 1410 does, however, overlap with a portion of additional structure 1436. The mode travels efficiently and is contained in waveguide 1410, continues to be contained in the additional structures 1432, 1434, and 1436 along with waveguide 1410, then is expanded in the area that includes additional structures 1432, 1434, and 1436 without waveguide 1410. Photonics device 1400 thus includes a bilayer trident handoff design.

An advantage of the bilayer trident handoff is its cost-efficient design. Additional structures 1432, 1434, and 1436 may have an easier fabrication process than TFLC electro-optic materials. For example, the thickness is generally easier to control and has fewer variations. It is simpler and less costly to etch steeper sidewall angles and sidewalls that are smoother (with lower surface roughness) in materials used for additional structures 1432, 1434, and 1436 than TFLC electro-optic materials. Materials, such as silicon nitride, used for additional structures 1432, 1434, and 1436 may also be used to achieve smaller critical dimensions. Further such a design may be used in embodiments in which the TE mode needs to be optimized, and not the TM mode.

Photonics device 1400 functions in an analogous manner to photonics devices 300, 100, and 1200. Photonics device 1400 may thus share the benefits of photonics devices 100, 300, and/or 1200. For example, photonics device 1400 may be more robust against thickness variations in the TFLC material(s) used for waveguide 1410, may have reduced optical coupling losses, and/or improved control over the optical mode. In addition, photonics device 1400 may be more cost effective to fabricate.

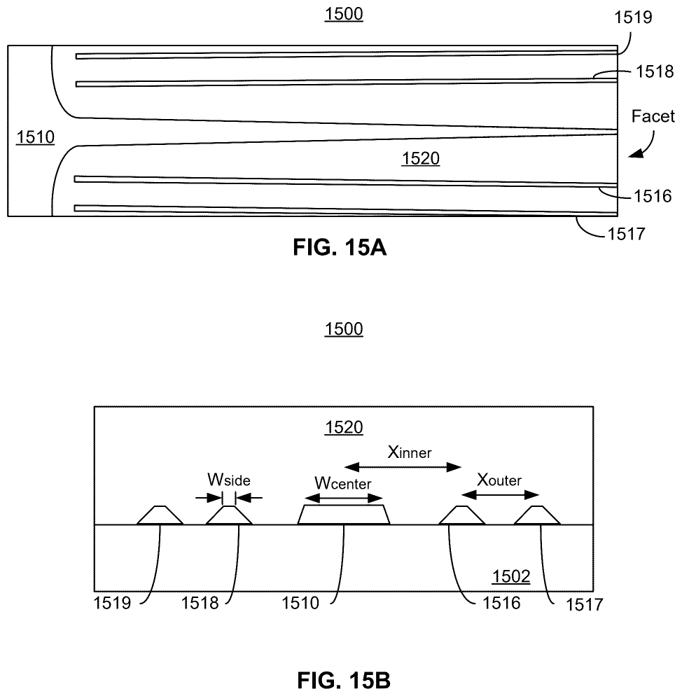

FIGS. 15A-15B depict an embodiment of photonics device 1500 that may have improved optical coupling. FIG. 15A depicts a top view of photonics device 1500. FIG. 15B depicts a cross-sectional view of photonics device 1500 at line B-B. Photonics device 1500 is analogous to photonics devices 1200 and 1300. Thus, photonics device 1500 includes waveguide 1510, substrate (not shown), cladding 1520, passivation layer 1530, and waveguiding structures 1516 and 1518 that are analogous to waveguide 1210, cladding 1220, and waveguiding structures 1216 and 1218. Additional structures (and other structures) analogous to those in photonics devices 100, 300, 400A, 400B, 500, 600, 700, 800, 900, 1000, 1100, 1200, 1300, 1300′, and/or 1400 may also be provided. Photonics device 1500 also includes a device portion and coupling portion proximate to the facet. For example, in addition to waveguide 1510, electrodes (not explicitly shown) and/or other components may be included in the device portion of photonics device 1500. In addition, photonics device 1500 includes waveguiding structures 1517 and 1519 that are analogous to structures 1516 and 1518. In some embodiments, such structures are formed of TFLC electro-optic materials.

Photonics device 1500 thus includes five structures in the same layer: waveguide 1510 and additional waveguiding structures 1516, 1517, 1518, and 1519. Photonics device may thus be termed a pentadent structure. Waveguiding structures 1516, 1517, 1518, and 1519 may be used to form an edge coupler that allows the transfer power from a chip to an external element (e.g. a fiber) with a specific ratio of TM to TE power transfer. Photonics device 1500 may compensate for on-chip differences in TM and TE power levels, for example in applications where such a balance is critical. For example, if there is an on-chip difference of 0.5 dB between the power output to the TE mode and the power output of the TM mode, a pentadent can be created such that there is a 0.5 dB difference favoring the other polarization. This may result in the same (or almost the same) power on both signals.

Four waveguiding structures 1516, 1517, 1518, and 1519 are used in the same layer as waveguide 1510. In various embodiments, waveguiding structures 1516, 1517, 1518, and 1519 are the same TFLC material as waveguide 1510, a different TFLC material from waveguide 1510, or a material of a similar refractive index to a TFLC. For example, silicon, silicon nitride, silicon dioxide, silicon oxynitride, aluminum oxide, and/or aluminum nitride might be used. Waveguide 1510 in conjunction with waveguiding structures 1516, 1517, 1518, and 1519 provide a photonic chip-to-fiber edge coupler that may be used with both TE (parallel to the plane of the chip) and TM (normal to the plane of the chip) polarized light.

Waveguide 1510 and waveguiding structures 1516, 1517, 1518, and 1519 are approximately parallel. The center of these is the signal-bearing structure (waveguide 1510), used to guide light. On each side, waveguide 1510 has parallel structures 1516 and 1518 separated from the center by a pitch of Xinner, and outer structures 1517 and 1519 separated from the center by a pitch of Xouter. In some embodiments:

$${x}_{inner} ∈ ∼ [ 0.8 , 4. ] μ m$$

$${x}_{outer} ∈ ∼ [ 2.3 , 9. ] μ m$$

Waveguide 1510 has a width (top width) of Wcenter. Wcenter is wide enough that waveguide 1510 can support the propagation of a fundamental TE and TM mode. In some embodiments, waveguide 1510 need not be wide enough that this condition can be satisfied independently of the supporting structures. In some embodiments:

$$W center ∈ ∼ [ 0.2 , 0.5 ] μ m$$

The four waveguiding structures 1516, 1517, 1518, and 1519 are generally the shape of a waveguide, but are submodal. In other word, Wside is too narrow for the structure to support a waveguide mode of its own. In some embodiments:

$${w}_{s i d e} < ∼ 0.3 μ m$$

The applications for pentadent structure of photonics device 1500 may be different from trident and other n-dent edge couplers because of a tunability for polarization. Through careful selection of Xinner, Xouter, Wcenter, and Wside, the desired TE and TM modes may be tuned such that a specific ratio of coupling efficiencies is achieved. This may then be used to offset on-chip imbalances when it is desired that the TE and TM signals have the same power for propagation through an off-chip component, such as a fiber. This may improve performance over a monolayer trident in that it uses the inherent difference in width between the fundamental TE and TM modes to create different stretch vectors for each.

The ratios between Xinner, Xouter, and Wcenter may be engineered to provide the desired TE and TM polarization of light. In some embodiments:

$${w}_{center} ∈ ∼ [ 0.2 , 0.5 ] μ m$$

From there, the following may be defined:

$${r}_{i c} {=}^{Δ} \frac{{x}_{i n n e r}}{{w}_{center}} ∈ ∼ [ 4 , 8 ]$$

$${D}_{i o} {=}^{Δ} {x}_{outer} - {x}_{i n n e r} ∈ ∼ [ 1.5 , 5 ] μ m$$

Using those relationships, at least some possible ranges for xinner and xouter may be derived:

$${x}_{inner} ∈ ∼ [ 0.8 , 4. ] μ m$$

provided this does not cause the inner ridges and signal-bearing waveguide to overlap, and

$${x}_{outer} ∈ ∼ [ 2.3 , 9. ] μ m$$

Provided that this does not cause any of the shapes in the structure to overlap with each other, and that xₒᵤₜₑᵣ>xᵢₙₙₑᵣ.

Photonics device 1500 functions in an analogous manner to photonics devices described herein. Photonics device 1500 may thus share at least some of the benefits of other photonics devices described herein. In addition, photonics device 1500 may allow for improved selection of the polarization of the optical signal.

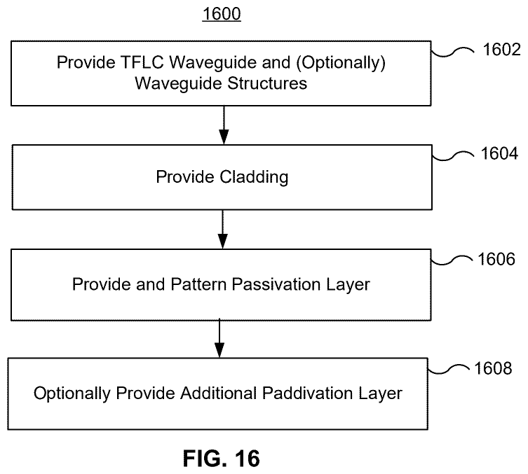

FIG. 16 is a flow chart depicting an embodiment of method 1600 for providing a photonics device that may have improved optical coupling. Method 1600 is described in the context of processes that may have sub-processes. Although described in a particular order, another order not inconsistent with the description herein may be utilized. For example, in some embodiments, portions of processes may be interleaved. Method 1600 is also described in the context of photonics devices 100, 300, and 1500. However, method 1600 may be used with other electro-optic devices including but not limited to photonics devices 400A, 400B, 500, 600, 700, 800, 900, 1000, 1100, 1200, 1300, 1300′, and/or 1400.

A TFLC waveguide is formed, at 1602. Thus, the first portion of the waveguide in a device region and a second portion of the waveguide is in a coupling region are formed. In some embodiments, the waveguide terminates at a facet of the photonics device. These portions of the waveguide may be formed together at 1602. In addition, waveguiding structures adjacent and in the same layer as the waveguide may be formed at 1602. The additional waveguiding structures are adjacent to the portion of the waveguide in the coupling region and closer to the substrate than the additional structures formed in 1606 are. Cladding is also provided, at 1604. In some embodiments, the cladding is planarized. A passivation layer is then provided and patterned, at 1606. Thus, a passivation layer may be deposited or grown. In some embodiments, the passivation layer includes at least one of silicon nitride, silicon oxynitride, silicon dioxide, aluminum oxide, or aluminum nitride. Portions of the passivation layer may then be removed. In some embodiments, additional structures are provided at 1606. In some embodiments, an aperture in the coupling region is provided. In some embodiments, no aperture may be provided. Also in some embodiments, an additional passivation layer is provided, at 1608. Thus, the aperture formed may be sealed. The cladding separates the additional structures from the waveguide and any waveguiding structures formed. The cladding has a cladding index of refraction that is less than that of the passivation layer and the additional structures formed from the passivation layer.

For example, waveguide 310 and cladding 320 may be provided at 1602 and 1604. Passivation layer 330 may be deposited and portions removed to form additional structures 332 and 334, at 1606. An additional passivation layer (e.g. analogous to layer 1140) may be provided at 1608. In another example, waveguide 1210 and waveguiding structures 1216 and 1218 may be provided at 1602. Waveguiding structures 1216 and/or 1218 may be provided from the same TFLC layer as waveguide 1210 or another material (e.g., SiN) may be used. Cladding 1220 is provided at 1604. A passivation layer and/or additional structures 1232, 1234, and 1236 may be provided at 1606. In some embodiments, another passivation layer is provided at 1608. In another example, waveguide 1510 and waveguiding structures 1516, 1516, 1518, and 1519 may be provided at 1602. Waveguiding structures 1516, 1516, 1518, and/or 1519 may be provided from the same TFLC layer as waveguide 1510 or another material (e.g., SiN) may be used. Cladding 1520 is provided. A passivation layer may be provided in 1606. In some embodiments, an aperture might be formed in the passivation layer. In some embodiments, aperture may be formed. An additional passivation layer might be formed at 1608. Using method 1600, photonics devices 100, 200, 300, 400A, 400B, 500, 600, 700, 800, 900, 1000, 1100, 1200, 1300, 1300′, 1400, and/or 1500 may be formed. Thus, the benefits described herein may be achieved.

Although the foregoing embodiments have been described in some detail for purposes of clarity of understanding, the invention is not limited to the details provided. There are many alternative ways of implementing the invention. The disclosed embodiments are illustrative and not restrictive.

1. A photonics device, comprising:
a device region having a first portion of a waveguide therein; and
a coupling region including a second portion of the waveguide, at least one additional structure, and a cladding separating the at least one additional structure from the second portion of the waveguide, the cladding having a cladding index of refraction, the at least one additional structure having at least one index of refraction greater than the cladding index of refraction;
wherein the waveguide includes at least one thin film lithium-containing (TFLC) electro-optic material.

2. The photonics device of claim 1, further comprising:
a substrate, the second portion of the waveguide closer to the substrate than the at least one additional structure is.

3. The photonics device of claim 2, wherein the at least one additional structure is part of a passivation layer having an aperture in the coupling region.

4. The photonics device of claim 3, wherein the passivation layer includes at least one of silicon nitride, silicon oxynitride, silicon dioxide, aluminum oxide, or aluminum nitride.

5. The photonics device of claim 3, wherein a first portion of the passivation layer extends into the device region and covers the first portion of the waveguide; and
wherein the at least one additional structure includes a plurality of structures.

6. The photonics device of claim 5, wherein the plurality of structures is separated by not more than five micrometers and are not more than ten micrometers from the second portion of the waveguide.

7. The photonics device of claim 6, wherein the coupling region terminates at a facet of the photonics device and wherein the waveguide terminates a distance from the facet.

8. The photonics device of claim 2, further comprising:
a plurality of additional waveguiding structures adjacent to the second portion of the waveguide and closer to the substrate than the at least one additional structure is.

9. The photonics device of claim 8, wherein the at least one additional structure includes a plurality of additional structures.

10. The photonics device of claim 9, wherein the plurality of additional structures is aligned with the second portion of the waveguide and the plurality of additional waveguiding structures.

11. The photonics device of claim 8, wherein the plurality of additional waveguiding structures include at least one additional TFLC electro-optic material.

12. The photonics device of claim 1, further comprising:
a passivation layer on the coupling region.

13. The photonics device of claim 12, wherein the coupling region terminates in a facet and wherein the passivation layer is on the facet.

14. A photonics device, comprising:
a substrate;
a waveguide, a first portion of the waveguide being in a device region, a second portion of the waveguide being in a coupling region that terminates at a facet of the photonics device;
a passivation layer including an aperture and a plurality of additional structures in the coupling region, the second portion of the waveguide being closer to the substrate than the plurality of additional structures is; and
a cladding separating the plurality of additional structures from the second portion of the waveguide, the cladding having a cladding index of refraction, plurality of additional structures having at least one index of refraction greater than the cladding index of refraction;
wherein the waveguide includes at least one thin film lithium-containing (TFLC) electro-optic material.

15. The photonics device of claim 14, further comprising:
a plurality of additional waveguiding structures adjacent to the second portion of the waveguide and closer to the substrate than plurality of additional structures is, the plurality of additional waveguiding structures including at least one additional TFLC electro-optic material.

16. The photonics device of claim 14, further comprising:
an additional passivation layer on the coupling region.

17. A method, comprising:
providing a waveguide on a substrate, a first portion of the waveguide being in a device region, a second portion of the waveguide being in a coupling region that terminates at a facet of a photonics device;
providing cladding; and
providing a passivation layer including an aperture and a plurality of additional structures in the coupling region, the second portion of the waveguide being closer to the substrate than the plurality of additional structures is, the cladding separating plurality of additional structures from the second portion of the waveguide, the cladding having a cladding index of refraction, the plurality of additional structures having at least one index of refraction greater than the cladding index of refraction;
wherein the waveguide includes at least one thin film lithium-containing (TFLC) electro-optic material.

18. The method of claim 17, wherein providing the waveguide further includes:
providing a plurality of additional waveguiding structures adjacent to the second portion of the waveguide and closer to the substrate than the plurality of additional structures is, the plurality of additional waveguiding structures including at least one additional TFLC electro-optic material.

19. The method of claim 17, wherein the passivation layer includes at least one of silicon nitride, silicon oxynitride, silicon dioxide, aluminum oxide, or aluminum nitride.

20. The method of claim 17, further comprising:
providing an additional passivation layer on the coupling region.
